(19) United States
(12) Patent Application Publication
(10) Pub. No.: US 2007/0174723 A1
(43) Pub. Date: Jul. 26, 2007

(54) Sub-second, zero-packet loss adapter failover

(76) Inventors: Omar Cardona, Austin, TX (US); James Brian Cunningham, Austin, TX (US); Jeffrey Paul Messing, Round Rock, TX (US); Jorge Rafael Nogueras, Austin, TX (US)

Correspondence Address: IBM CORP (YA);C/O YEE & ASSOCIATES PC, P.O. BOX 802333, DALLAS, TX, 75380, US

(21) Appl. No.: 11/334,662

(22) Filed: Jan. 18, 2006

(51) Int. Cl. G06F 11/00

(52) U.S. Cl. 714/43

(57) ABSTRACT

A computer implemented method, data processing system, and a computer program product are provided for managing an adapter failure. A first adapter is monitored for adapter failure. A second adapter is activated in response to detecting the adapter failure of the first adapter. In response to detecting the first adapter failure, any unsent packets located in a queue associated with the first adapter are redirected to a queue associated with the second adapter. These redirected packets form initial packets that are sent prior to sending any other packets.

### BACKGROUND OF THE INVENTION

1. Field of the Invention

The present invention relates generally to adapter failure. More specifically, the present invention relates to a sub-second, zero-loss adapter failover.

2. Description of the Related Art

EtherChannel and IEEE 802.3ad Link Aggregation are network port aggregation technologies that allow several Ethernet adapters to be aggregated together to form a single pseudo Ethernet device. The system considers these aggregated adapters as one adapter. Therefore, Internet Protocol is configured over the aggregated adapters as well as over any Ethernet adapter. In addition, all adapters in the EtherChannel or Link Aggregation are given the same hardware (MAC) address. As a result, the adapters are treated by remote systems as if they were one adapter. Both EtherChannel and IEEE 802.3ad Link Aggregation require support in the switch so the switch is aware which switch ports should be treated as one single switch port.

The main benefit of EtherChannel and IEEE 802.3ad Link Aggregation is that they have the network bandwidth of all of their adapters in a single network presence. If an adapter fails, network traffic is automatically sent on the next available adapter without disruption to existing user connections. The adapter is automatically returned to service on the EtherChannel or Link Aggregation when it recovers.

Ideally, after a link aggregation fails over to a backup adapter and takes over all of the traffic, the user should experience as little disruption as possible. In other words, there should be as little packet loss as possible. However, due to the fact that some packets are queued in the failing adapter, those packets are lost when the backup adapter takes over.

### SUMMARY OF THE INVENTION

The aspects of the present invention provide a computer implemented method, data processing system and computer program product for managing an adapter failure. A first adapter is monitored for adapter failure. In response to detecting an adapter failure, a second adapter is activated. Any unsent packets located in a first queue associated with the first adapter are directed to a second queue associated the second adapter. The second adapter sends the initial packets in the second queue prior to sending any other packets.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 depicts a block diagram of a data processing system in which aspects of the present invention may be implemented;

FIG. 3 depicts a known functional block diagram of a link aggregation failover in accordance with an illustrative embodiment of the present invention;

FIG. 4 depicts a diagram of a link aggregation failover system in accordance with an illustrative embodiment of the present invention;

FIG. 5 depicts an exemplary packet queuing process in accordance with an illustrative embodiment of the present invention;

FIG. 6 illustrates an exemplary operation of a link aggregation layer in accordance with an illustrative embodiment of the present invention;

FIG. 7 illustrates an exemplary operation of a primary adapter in accordance with an illustrative embodiment of the present invention; and

FIG. 8 illustrates an exemplary operation of a backup adapter in accordance with an illustrative embodiment of the present invention.

### DETAILED DESCRIPTION OF THE PREFERRED EMBODIMENT

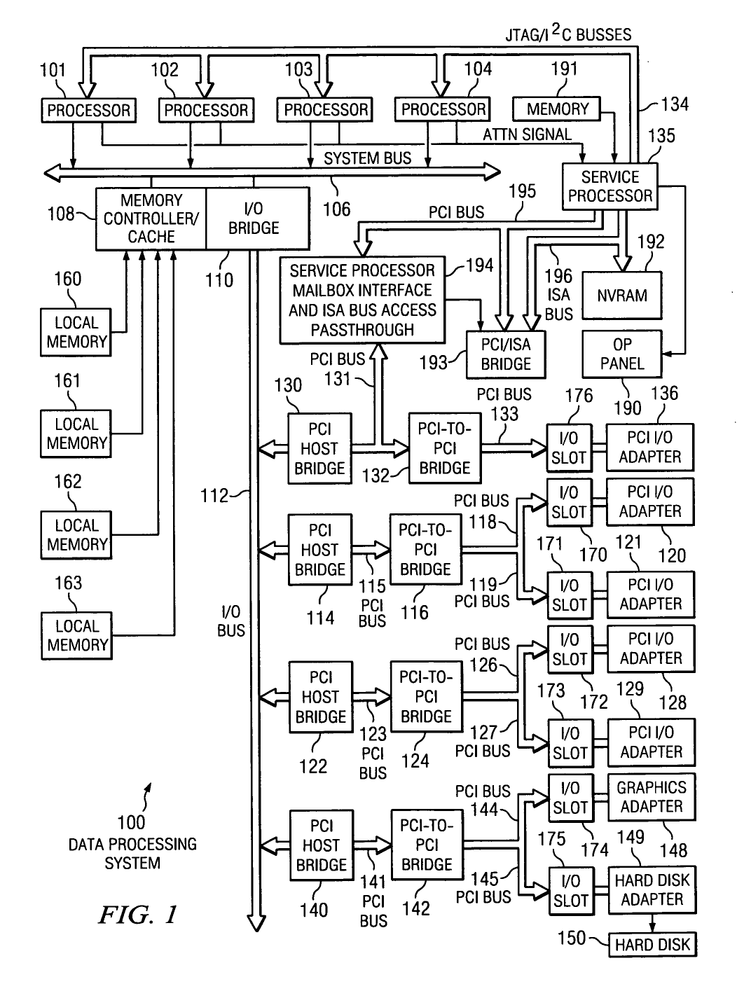

The aspects of the present invention relate to a sub-second, zero-loss adapter failover. With reference now to the figures, and in particular with reference to FIG. 1, a block diagram of a data processing system is depicted in which the present invention may be implemented. Data processing system 100 may be a symmetric multiprocessor (SMP) system including a plurality of processors 101, 102, 103, and 104, which connect to system bus 106. For example, data processing system 100 may be an IBM eServer, a product of International Business Machines Corporation in Armonk, New York, implemented as a server within a network. Alternatively, a single processor system may be employed. Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 connects for a display device (not shown), while hard disk adapter 149 connects to and controls hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to each of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Linux or OS/400 operating system may be operating within logical partition P3.

Peripheral component interconnect (PCI) host bridge 114 connected to I/O bus 112 provides an interface to PCI local bus 115. A number of PCI input/output adapters 120-121 connects to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128-129. PCI I/O adapters 128-129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for a PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 connects to the ISA bus 196. Service processor 135 connects to service processor mailbox interface and ISA bus access pass-through logic 194 through its local PCI bus 195. Service processor 135 also connects to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

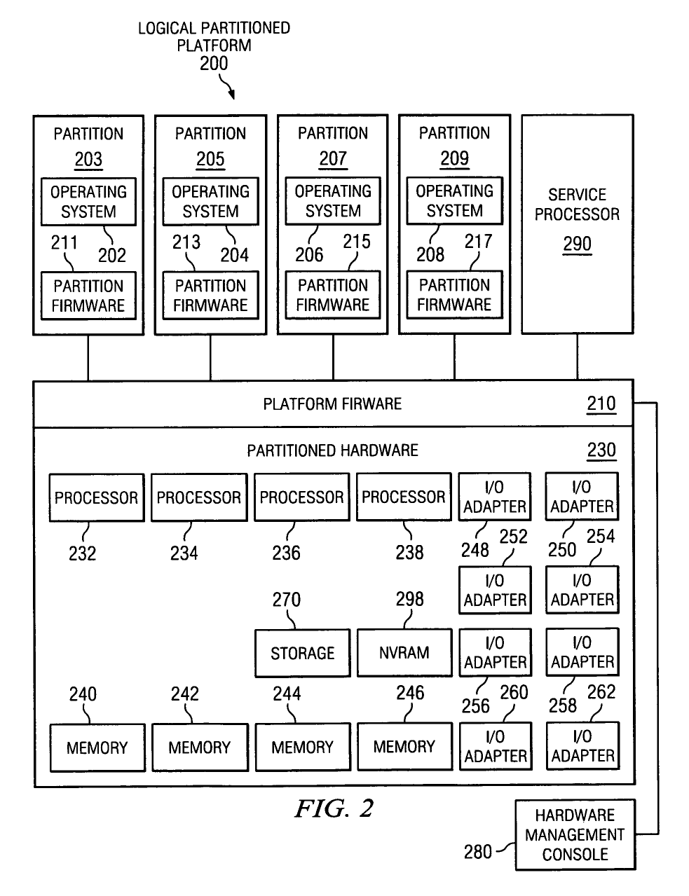

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor. OS/400 is used only as an example in these illustrative embodiments. Of course, other types of operating systems, such as AIX and Linux, may be used depending on the particular implementation. Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232-238, a plurality of system memory units 240-246, a plurality of input/output (I/O) adapters 248-262, and a storage unit 270. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

Aspects of the present invention provide for managing an adapter failure. A primary adapter is monitored for adapter failure. Responsive to detecting an adapter failure, a backup adapter is activated. Any unsent packets located in a queue associated with the primary adapter are directed to a queue associated with the backup adapter. The backup adapter sends the initial packets in the second queue prior to sending any other packets.

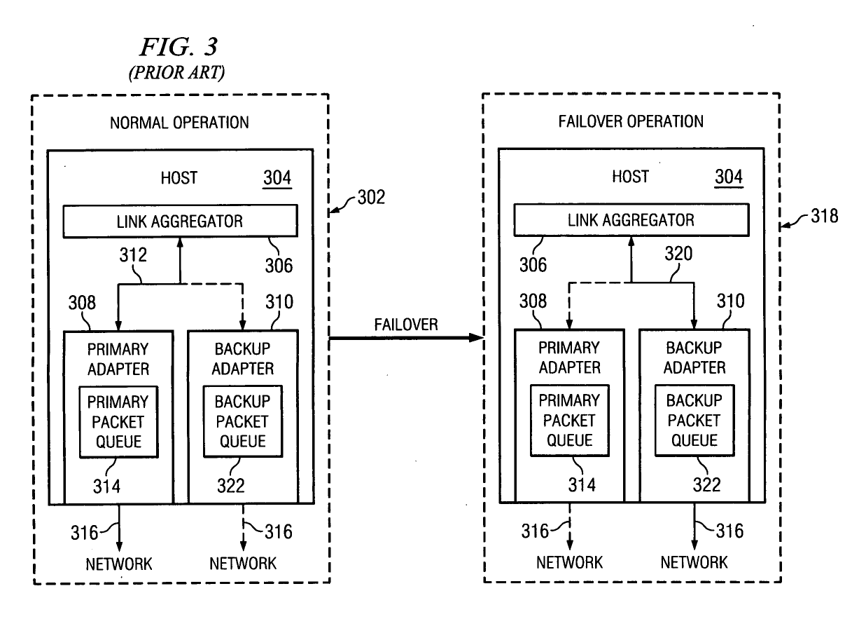

FIG. 3 depicts a known functional block diagram of a link aggregation failover in accordance with an illustrative embodiment of the present invention. In normal operation 302, host 304 contains link aggregator 306. Link aggregator 306 connects to primary adapter 308 and backup adapter 310. In a normal process, incoming packets are sent through link aggregator 306 using connection 312 to primary adapter 308 and queued in primary packet queue 314 by primary adapter 308. As primary adapter 308 processes the packets stored in primary packet queue 314, primary adapter 308 sends the packets out to network 316. During failover operation 318, link aggregator 306 activates backup adapter 310 and sends incoming packets using connection 320 to backup adapter 310. Backup adapter 310 then queues the packets in backup packet queue 322. As backup adapter 310 processes the packets stored in backup packet queue 322, the packets are sent out to network 316. However, due to the fact that some packets remain queued in primary packet queue 314 of primary adapter 308, those packets are lost when backup adapter 310 takes over.

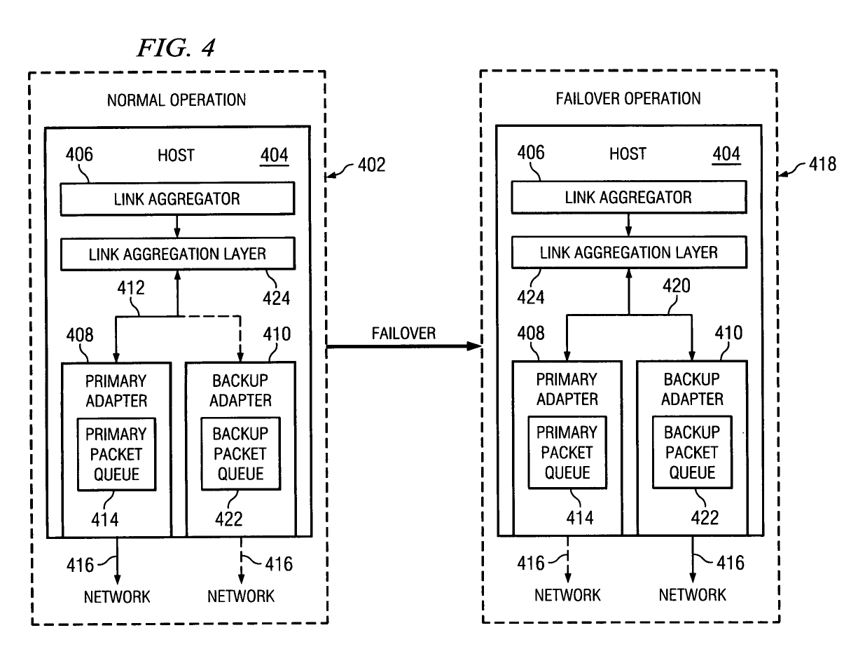

FIG. 4 depicts a diagram of a link aggregation failover system in accordance with an illustrative embodiment of the present invention. As an inventive aspect of the present invention, in normal operation 402, host 404 contains link aggregator 406 that is connected to primary adapter 408 and backup adapter 410 via link aggregation layer 424. In normal process, incoming packets are sent through link aggregator 406 and link aggregation layer 424 using connection 412 to primary adapter 408 and queued in primary packet queue 414. As primary adapter 408 processes the packets stored in primary packet queue 414, primary adapter 408 sends the packets out to network 416. During failover operation 418, link aggregation layer 424 detects that primary adapter 408 has failed. The detection of primary adapter 408 failing may be through primary adapter 408 sending link aggregation layer 424 an indication that primary adapter 408 has failed, or other suitable means of detection.

Link aggregation layer 424 requests that primary adapter 408 send a pointer indicating the point in primary packet queue 414 of the last packet successfully sent. Link aggregation layer 424 sends the pointer indicating the point in primary packet queue 414 after the last packet successfully sent using connection 420 to backup adapter 410. Link aggregation layer 424 then activates backup adapter 410 and also sends any new incoming packets using connection 412 to backup adapter 410. Backup adapter 410 then uses the pointer to enqueue pending packets from primary packet queue 414 and any new incoming packets in backup packet queue 422. As backup adapter 410 processes the packets stored in backup packet queue 422, packets enqueued from primary packet queue 414 are sent out to network 416 in order and before any newly-queued packets.

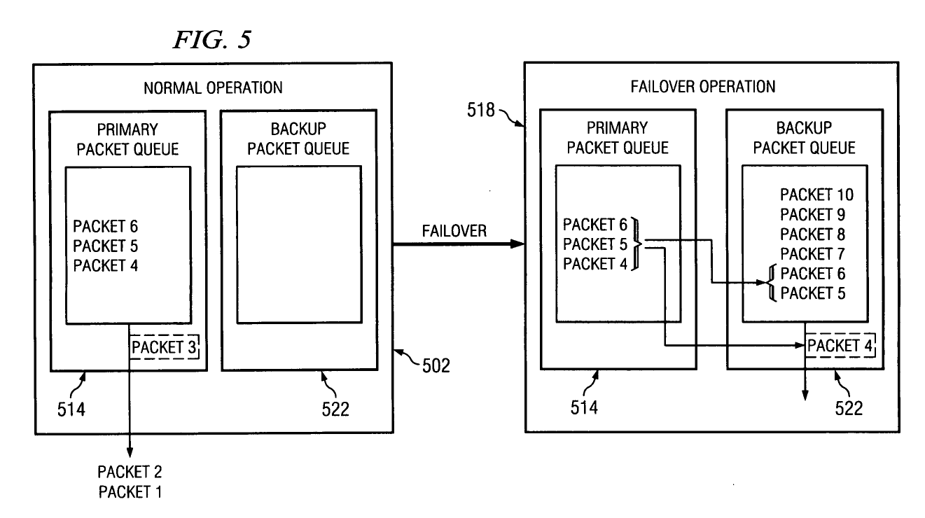

FIG. 5 depicts an exemplary packet queuing process in accordance with an illustrative embodiment of the present invention. In normal operation 502, incoming packets are sent through a link aggregator, link aggregation layer, and primary adapter and queued in primary packet queue 514. As shown in normal operation 502, packets 1 and 2 have been sent out on the network, packet 3 is being processed, and packets 4, 5, and 6 are queued.

During failover operation 518, the link aggregation layer detects that primary adapter has failed, requests that primary adapter send a pointer indicating the point in primary packet queue 514 of the last packet successfully sent, sends the pointer to the backup adapter indicating the point in primary packet queue 514 of the last packet successfully sent, and activates the backup adapter. The backup adapter then uses the pointer and enqueues the pending packets, packets 4, 5, and 6, from primary packet queue 514 and any new incoming packets, packets 7, 8, 9, and 10, in backup packet queue 522. Then, the backup adapter processes the packets stored in backup packet queue 512 as shown as packet 4 being processed. The queued packets from primary packet queue 514 are sent out in order, exemplary shown as packets 4, 5, and 6, and before any newly queued packets, exemplary shown as packets 7, 8, 9, and 10.

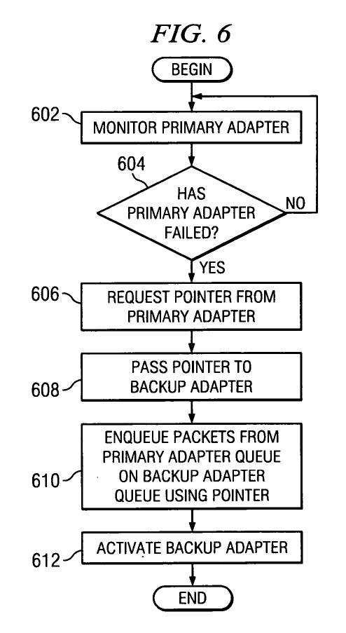

FIG. 6 illustrates an exemplary operation of a link aggregation layer in accordance with an illustrative embodiment of the present invention. The process in FIG. 6 may be implemented in a link aggregation layer, such as link aggregation layer 424 in FIG. 4. As the operation begins, the primary adapter is monitored by the link aggregation layer (step 602). At step 604, link aggregation layer determines if the primary adapter has failed. If the primary adapter has not failed, the operation returns to step 602. If at step 604, the primary adapter has failed, the link aggregation layer requests a pointer from the primary adapter indicating the last point in the queue where the last packet was successfully sent (step 606). The link aggregation layer receives the pointer and then passes the pointer to the backup adapter (step 608). The link aggregation layer assists the backup adapter in enqueuing the pending packets from the primary adapter (step 610). The link aggregation layer then activates the backup adapter (step 612), with the operation ending thereafter.

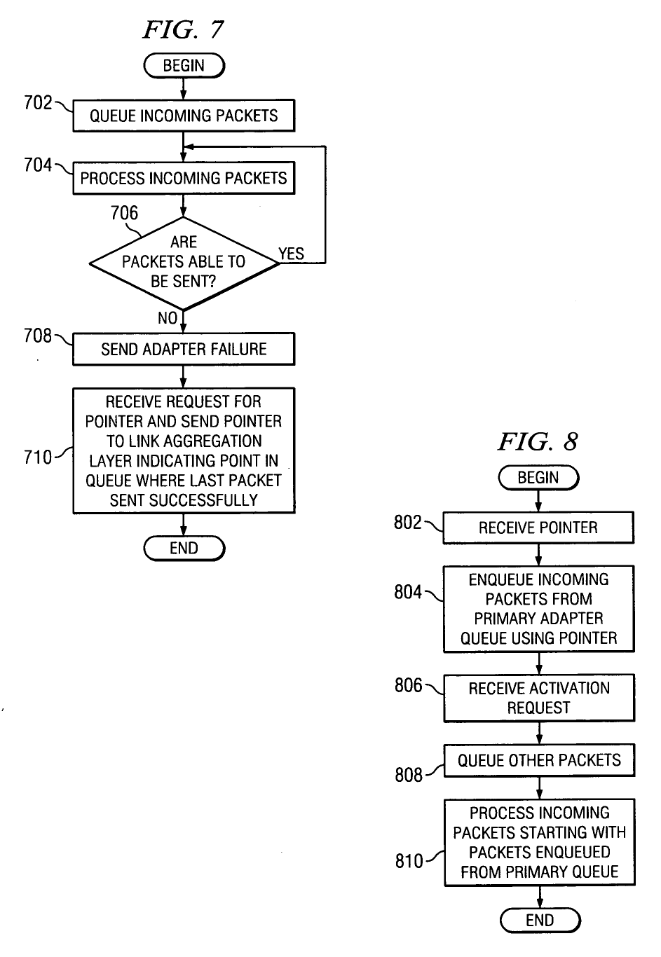

FIG. 7 illustrates an exemplary operation of a primary adapter in accordance with an illustrative embodiment of the present invention. The process in FIG. 7 may be implemented in a primary adapter, such as primary adapter 408 in FIG. 4. As the operation begins the primary adapter queues incoming packets in the primary packet queue (step 702). The primary adapter processes the packets in the primary packet queue (step 704) until the packets are no longer able to be sent (step 706), indicating the primary adapter has failed. If the primary adapter has failed (step 706), the adapter sends a failure notice to the link aggregation layer (step 708). Once a request for a pointer has been received, the primary adapter sends the pointer to the link aggregation layer indicating the point in the queue after which the last packet was successfully sent (step 710), with the operation ending thereafter.

FIG. 8 illustrates an exemplary operation of a backup adapter in accordance with an illustrative embodiment of the present invention. The process in FIG. 8 may be implemented in a backup adapter, such as backup adapter 410 in FIG. 4. As the operation begins, the backup adapter receives the pointer from the link aggregation layer (step 802). Once a pointer is received, the backup adapter enqueues the packets in the backup packet queue from the primary packet queue using the pointer received from the link aggregation layer (step 804). The backup adapter then receives an action command from the link aggregation layer that causes activation of the backup adapter (step 806). At this point the backup adapter may also queue other packets which are received through the link aggregation layer (step 808). The backup adapter may either immediately start processing the first packet enqueued from the primary packet queue, or wait until all of the packets from the primary packet queue are queued in the backup packet queue to start processing the packets (step 810). In either case, the backup adapter starts processing the packets from the primary packet queue before processing any new incoming packets.

The aspects of the present invention provide for a sub-second, zero-loss adapter failover. Using the method described guarantees an in-order sending of the packets that are queued in the primary packet queue. Additionally, the perceived failover time from remote systems may decrease, since no packets timeouts or retransmits will occur. The same method described above may be applied at any point in time if the primary adapter recovers and a switch back to the primary adapter from the backup adapter occurs. That is, the primary adapter will receive a pointer to the backup adapter's first unsent packet in the backup packet queue.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing an adapter failure, the computer implemented method comprising:
monitoring a first adapter for the adapter failure;
responsive to detecting the adapter failure, directing unsent packets located in a first queue for the first adapter to a second queue for a second adapter to form initial packets;
responsive to detecting the adapter failure, activating the second adapter; and
sending the initial packets in the second queue prior to sending any other packets.

2. The computer implemented method of claim 1, wherein directing the unsent packets located in the first queue for the first adapter comprises:
requesting a pointer from the first adapter; and
sending the pointer to the second adapter.

3. The computer implemented method of claim 2, wherein the pointer indicates a point in the first queue associated with the first adapter where a last successful packet was sent.

4. The computer implemented method of claim 2, wherein sending the pointer to the second adapter further comprises:
determining if the pointer has been received by the second adapter;
responsive to the receipt of the pointer by the second adapter, directing unsent packets located in a first queue for the first adapter to a second queue for the second adapter to form initial packets; and
sending the initial packets in the second queue prior to sending any other packets in the second queue.

5. The computer implemented method of claim 1, wherein the unsent packets and the other packets are queued into the second queue.

6. The computer implemented method of claim 1, wherein detecting the failure in the first adapter further comprises:
receiving an adapter failure notification from the first adapter.

7. The computer implemented method of claim 1, further comprising:
detecting a recovery of the first adapter;
responsive to detecting the recovery, directing unsent packets located in the second queue for the second adapter to the first queue for the first adapter to form recovery packets;
responsive to detecting the recovery, activating the first adapter; and
sending the recovery packets in the first queue prior to sending any other packets.

8. A data processing system comprising:
a link aggregation layer;
a first adapter; and
a second adapter, wherein the link aggregation layer executes a set of instructions to monitor the first adapter for the adapter failure; direct unsent packets located in a first queue for the first adapter to a second queue for the second adapter to form initial packets in response to detecting the adapter failure; activate the second adapter in response to detecting the adapter failure; and the second adapter executes a set of instructions to send the initial packets in the second queue prior to sending any other packets.

9. The data processing system of claim 8, wherein the link aggregation layer executing the set of instructions to direct the unsent packets located in the first queue for the first adapter includes executing a set of instructions to request a pointer from the first adapter; and send the pointer to the second adapter.

10. The data processing system of claim 9, wherein the pointer indicates a point in the first queue associated with the first adapter where a last successful packet was sent.

11. The data processing system of claim 9, wherein the link aggregation layer executing the set of instructions to send the pointer to the second adapter further includes the second adapter executing a set of instructions to determine if the pointer has been received by the second adapter; direct unsent packets located in a first queue for the first adapter to a second queue for the second adapter to form initial packets in response to the receipt of the pointer by the second adapter; and send the initial packets in the second queue prior to sending any other packets in the second queue.

12. The data processing system of claim 8, wherein the unsent packets and the other packets are queued into the second queue.

13. The data processing system of claim 8, wherein the link aggregation layer executing the set of instructions to detecting the failure in the first adapter further includes executing a set of instructions to receive an adapter failure notification from the first adapter.

14. The data processing system of claim 8, further including the link aggregation layer executing the set of instructions to detect a recovery of the first adapter; direct unsent packets located in the second queue for the second adapter to the first queue for the first adapter to form recovery packets in response to detecting the recovery; activate the first adapter responsive to detecting the recovery; and the first adapter executing the set of instructions to send the recovery packets in the first queue prior to sending any other packets.

15. A computer program product comprising:
a computer usable medium including computer usable program code for managing an adapter failure, the computer program product including:
computer usable program code for monitoring a first adapter for the adapter failure;
computer usable program code for directing unsent packets located in a first queue for the first adapter to a second queue for a second adapter to form initial packets in response to detecting the adapter failure;
computer usable program code for activating the second adapter in response to detecting the adapter failure; and
computer usable program code for sending the initial packets in the second queue prior to sending any other packets.

16. The computer program product of claim 15, wherein the computer usable program code for directing the unsent packets located in the first queue for the first adapter comprises:
computer usable program code for requesting a pointer from the first adapter; and
computer usable program code for sending the pointer to the second adapter.

17. The computer program product of claim 16, wherein the pointer indicates a point in the first queue associated with the first adapter where a last successful packet was sent.

18. The computer program product of claim 16, wherein the computer usable program code for sending the pointer to the second adapter further comprises:
computer usable program code for determining if the pointer has been received by the second adapter;
computer usable program code for directing unsent packets located in a first queue for the first adapter to a second queue for the second adapter to form initial packets in response to the receipt of the pointer by the second adapter; and
computer usable program code for sending the initial packets in the second queue prior to sending any other packets in the second queue.

19. The computer program product of claim 15, wherein the computer usable program code for detecting the failure in the first adapter further comprises:
computer usable program code for receiving an adapter failure notification from the first adapter.

20. The computer program product of claim 15, further comprising:
computer usable program code for detecting a recovery of the first adapter;
computer usable program code for directing unsent packets located in the second queue for the second adapter to the first queue for the first adapter to form recovery packets in response to detecting the recovery;
computer usable program code for activating the first adapter in response to detecting the recovery; and
computer usable program code for sending the recovery packets in the first queue prior to sending any other packets.
